(19) United States
(12) Patent Application Publication
(10) Pub. No.: US 2026/0227585 A1
(43) Pub. Date: Aug. 6, 2026

(54) CHIP, MODULE, DEVICE, AND SYSTEM FOR OPTICAL INTERCONNECTION

(71) Applicant: SHANGHAI XIZHI TECHNOLGY CO., LTD., Shanghai (CN)

(72) Inventors: Yichen SHEN, Shanghai (CN); Huaiyu MENG, Shanghai (CN); Yelong XU, Shanghai (CN); Yanfei BAI, Shanghai (CN); Shiyue HUA, Shanghai (CN); Jian ZHU, Shanghai (CN); Shanshan YU, Shanghai (CN)

(21) Appl. No.: 19/633,948

(22) Filed: Mar. 30, 2026

Related U.S. Application Data
(63) Continuation of application No. PCT/CN2025/095938, filed on May 20, 2025.

(30) Foreign Application Priority Data
May 28, 2024 (CN) 202410678356.4
Jun. 29, 2024 (CN) 202410867916.0

(51) Int. Cl. G02B 6/42; G02B 6/43

(52) U.S. Cl. CPC G02B 6/425; G02B 6/4261; G02B 6/428; G02B 6/4298; G02B 6/43; G02B 6/4296

(57) ABSTRACT

The present disclosure relates to a chip, a module, a device and a system employing the module for optical interconnection. The chip includes one or more photonic integrated circuit sub-modules, each comprising first optical switching units configured to selectively route optical signals, an on-chip optical switch optically connected to the first switching units, modulators optically connected to the switching units, and detectors at least partially connected to the on-chip optical switch. The submodules further include first and second optical couplers for interfacing with external optical fiber arrays, enabling bidirectional optical signal transmission.

### CROSS-REFERENCE TO RELATED APPLICATION(S)

This application claims priority and benefits from Chinese Invention Patent Application No. 2024106783564, entitled “Chip, Module, Device and System for Optical Interconnection”, filed on May 28, 2024, and Chinese Patent Application No. 2024108679160, entitled “Chip, Module, Device and System for Optical Interconnection,” filed on Jun. 29, 2024, the entire contents of each of which are incorporated herein by reference.

### FIELD OF THE INVENTION

The present disclosure relates generally to computer technologies, and more particularly to a photonic integrated circuit chip, an optical interconnection module, and an optical interconnection expansion card, as well as a computing device and a computing system using the optical interconnection module.

### BACKGROUND OF THE INVENTION

Computational demands for artificial intelligence (AI) models have increased at a rate that exceeds improvements in standalone computing hardware performance. As AI accelerators continue to improve through semiconductor process advancements and architectural innovations, interconnection bandwidth between AI accelerators becomes increasingly important. Interconnection networks have become a significant factor affecting overall system computational capability.

Industry initiatives, such as the Open Compute Project (OCP), have introduced standardized accelerator module form factors, including the OCP Accelerator Module (OAM), which have been adopted by leading graphics processing unit (GPU) suppliers. In some existing implementations, eight computing modules are mounted on a Universal Base Board (UBB) and interconnected through point-to-point printed circuit board (PCB) traces. Because relatively long PCB traces are required, the computing modules typically employ long-reach serializer/deserializer (SerDes) interfaces, such as CEI Long Range (LR) interfaces. In full-mesh configurations, each SerDes interface is dedicated to a specific peer computing module, which can limit the effective bandwidth available between individual pairs of computing modules.

In addition, the response of electrical channels tends to degrade as signal rates increase. Consequently, higher-speed interfaces often require more complex architectures and circuit designs, which may introduce additional latency, consume more power, and occupy greater chip area, thereby limiting the available input/output (I/O) bandwidth of the chip. Furthermore, longer metal interconnect distances may further exacerbate electrical loss characteristics, thereby limiting the interconnection distance between AI accelerators.

### SUMMARY OF THE INVENTION

Embodiments of the present disclosure provide a photonic integrated circuit chip, an optical interconnection module, and an optical interconnection expansion card, a computing device, and a system using the optical interconnection module. Compared with electrical interconnection, the loss of an optical channel remains substantially constant across different frequencies and is relatively small, such that optical interconnection can support longer transmission distances. In addition, the optical interconnection module can make the bandwidth within a node and between different nodes more uniform, which facilitates large-scale expansion of computing modules.

In one aspect, embodiments of the present disclosure relate to a photonic integrated circuit (PIC) chip comprising one or more photonic integrated circuit sub-modules, each photonic integrated circuit sub-module comprising:
a plurality of first optical switching units, each first optical switching unit comprising a first optical input port, a first optical output port, and a second optical output port, and being configured to selectively output an optical signal received at the first optical input port via either the first optical output port or the second optical output port;
at least one on-chip optical switch comprising a plurality of optical input ports and a plurality of optical output ports, wherein the plurality of optical input ports are respectively optically connected to the second optical output ports of the plurality of first optical switching units, and the at least one on-chip optical switch is configured to selectively output an optical signal received at any one of the plurality of optical input ports via at least one of the plurality of optical output ports;
a plurality of modulators optically connected to corresponding first optical input ports of the plurality of first optical switching units and configured to modulate information carried by an electrical signal onto the optical signal;
a plurality of detectors, at least a portion of the plurality of detectors being optically connected to the plurality of optical output ports of the at least one on-chip optical switch;
a plurality of first optical couplers configured to optically connect the first optical output ports of the plurality of first optical switching units to a first external optical fiber array; and
a second optical coupler optically connected to at least a portion of the plurality of detectors and configured to transmit optical signals from a second external optical fiber array to the portion of the plurality of detectors.

In some embodiments, each photonic integrated circuit sub-module further comprises a plurality of wavelength multiplexers and a plurality of demultiplexers.

The plurality of modulators are arranged as a plurality of modulator arrays, and the plurality of detectors are arranged as a plurality of detector arrays.

Each modulator array is optically connected to a corresponding first optical switching unit through a respective wavelength multiplexer of the plurality of wavelength multiplexers, wherein each wavelength multiplexer comprises a plurality of optical input ports and one optical output port, wherein each of the plurality of optical input ports is connected to a respective modulator of the modulator array, and the optical output port is connected to the first optical input port of a corresponding first optical switching unit.

Each detector array is optically connected to a corresponding optical output port of the at least one on-chip optical switch or to the second optical coupler via a respective demultiplexer of the plurality of demultiplexers, wherein each demultiplexer comprises one optical input port and a plurality of optical output ports, the optical input port is connected to one optical output port of the at least one on-chip optical switch or to the second optical coupler, and each of the plurality of optical output ports is connected to a respective detector in the detector array.

In some embodiments, a number of the detectors or detector arrays is twice a number of the modulators or modulator arrays, wherein a portion of the detectors or detector arrays is connected to the at least one on-chip optical switch and a second portion of the detectors or detector arrays is connected to the second optical coupler.

In some embodiments, at least a portion of the plurality of detectors or detector arrays are optically connected to the plurality of optical output ports of the at least one on-chip optical switch, and a second portion of the detectors or detector arrays are optically connected to the second optical coupler. In other embodiments, each photonic integrated circuit submodule further comprises a third optical switching unit, and the detectors or demultiplexers are optically connected to the at least one on-chip optical switch and the second optical coupler through the third optical switching unit, wherein a number of the detectors or detector arrays is equal to a number of the modulators or modulator arrays.

In some embodiments, the third optical switching unit comprises a first optical input port, a second optical input port, and an optical output port, the first optical input port being connected to the second optical coupler, the second optical input port being connected to an optical output port of the at least one on-chip optical switch, and the optical output port being connected to a respective detector or demultiplexer, wherein the third optical switching unit is configured to selectively establish optical communication between its first optical input port and its optical output port or between its second optical input port and its optical output port.

In some embodiments, the third optical switching unit is respectively disposed on an optical path between the detector or detector array and the at least one on-chip optical switch, and on an optical path between the detector or detector array and the second optical coupler.

In some embodiments, the third optical switching unit comprises a MEMS optical switching unit or a Mach-Zehnder interferometer (MZI) optical switching unit.

In some embodiments, the at least one on-chip optical switch comprises a plurality of second optical switching units.

The plurality of second optical switching units are configured to select transmission paths for optical signals input to the at least one on-chip optical switch such that the optical signals are output from at least one optical output port of the at least one on-chip optical switch.

In some embodiments, the first optical switching units and the second optical switching units are different types of optical switching units.

In some embodiments, the first optical switching unit comprises a MEMS optical switching unit or an MZI optical switching unit; and/or the second optical switching unit comprises an MZI optical switching unit.

In some embodiments, the first optical switching unit comprises an MZI optical circuit switching unit, the MZI optical circuit switching unit including:
a first beam splitter having one optical input port and two optical output ports;
a second beam splitter having two optical input ports and two optical output ports; and
two phase shifters respectively connected between the two optical output ports of the first beam splitter and the two optical input ports of the second beam splitter.

In some embodiments, each second optical switching unit comprises:
two beam splitters each having two optical input ports and two optical output ports, the two beam splitters including a first beam splitter and a second beam splitter; and
two phase shifters respectively connected between the two optical output ports of the first beam splitter and the two optical input ports of the second beam splitter.

In some embodiments, each modulator comprises at least one of: a microring modulator, a Mach-Zehnder modulator, and an electro-absorption modulator.

In some embodiments, each detector comprises a microring detector or a photodiode.

In some embodiments, each photonic integrated circuit sub-module further comprises:
a third optical coupler configured to receive light from an off-chip light source; and
an optical power splitter optically connected to the third optical coupler and configured to split input optical signal into a plurality of output lights having substantially equal power, the plurality of output lights being transmitted to respective modulators.

In another aspect, embodiments of the present disclosure relate to an optical interconnection module comprising the above PIC chip and a transceiver analog electrical chip.

The transceiver analog electrical chip is configured to convert a received first digital electrical signal into a driving analog electrical signal and transmit the driving analog electrical signal carrying information to at least one modulator of the PIC chip, or receive an analog electrical signal output from at least one detector of the PIC chip and convert the analog electrical signal into a second digital electrical signal, wherein the at least one modulator is configured to modulate the information carried by the driving analog electrical signal onto the optical signal.

In some embodiments, the transceiver analog electrical chip is disposed above the PIC chip and configured to receive the first digital electrical signal and/or transmits the second digital electrical signal through conductive vias extending through the PIC chip.

In some embodiments, the optical interconnection module further comprises an optical switching control analog electrical chip corresponding to the on-chip optical switch of the PIC chip and configured to control the plurality of second optical switching units to select transmission paths for an optical signal received at the on-chip optical switch such that the optical signal is output from a predetermined optical output port.

In some embodiments, the optical switching control analog electrical chip is disposed above the PIC chip and configured to receive an optical switching control analog signal through conductive vias extending through the PIC chip.

In some embodiments, the optical interconnection module further comprises a substrate, wherein the PIC chip is mounted on the substrate and the transceiver analog electrical chip is mounted on a side of the PIC chip opposite the substrate.

In addition, embodiments of the present disclosure further relate to an optical interconnection expansion card comprising:
a first printed circuit board (PCB);
the above optical interconnection module disposed on the first PCB;
a plurality of optical fiber interfaces disposed on the first PCB and optically connected to the optical interconnection module through the first external optical fiber array and the second external optical fiber array to implement optical communication with the optical interconnection module;
a plurality of electrical communication interfaces disposed on the first PCB and configured to receive the first digital electrical signals and/or transmit the second digital electrical signals;
a plurality of retimers disposed on the first PCB and communicatively connected to the plurality of electrical communication interfaces and the optical interconnection module, the plurality of retimers being configured to: retime the first digital electrical signals and transmit retimed electrical signals to the optical interconnection module; and/or retime second digital electrical signals received from the optical interconnection module and transmit the retimed signals through the plurality of electrical communication interfaces.

In some embodiments, each retimer comprises a plurality of communication channels, the plurality of electrical communication interfaces comprise a plurality of communication channels, and a total number of communication channels of the plurality of retimers is equal to a total number of electrical communication channels of the plurality of electrical communication interfaces.

In some embodiments, the plurality of retimers are communicatively connected to the optical interconnection module through PCB traces on the first PCB.

In some embodiments, the optical interconnection expansion card further comprises a laser module disposed on the first PCB and optically connected to the optical interconnection module through a third optical fiber array to transmit a laser beam to the optical interconnection module.

Embodiments of the present disclosure further relate to a computing device comprising:
a plurality of computing modules; and
a plurality of the above optical interconnection expansion cards;
wherein the plurality of computing modules are communicatively connected to the plurality of optical interconnection expansion cards.

In some embodiments of the present invention, the computing device further comprises a second printed circuit board (PCB),
wherein the plurality of computing modules are disposed on the second PCB,
the plurality of optical interconnection expansion cards are plugged into the second PCB, and
the plurality of computing modules are communicatively connected to the plurality of optical interconnection expansion cards through PCB traces on the second PCB.

Further, embodiments of the present disclosure also relate to a computing system comprising:
a plurality of the above computing devices; and
at least one switch;
wherein the plurality of optical interconnection expansion cards of the plurality of computing devices are communicatively connected to the at least one switch through optical fibers so as to communicatively connect the plurality of computing devices.

In some embodiments, the at least one switch comprises an optical circuit switch or an electrical switch including an optical module configured to perform optical communication with the plurality of optical interconnection expansion cards.

As described above, the optical interconnection structure described herein overcomes interconnection distance limitations associated with printed circuit board traces. Through long-distance optical fiber connections, existing multi-card computing systems may be decoupled, such that computational capacity scaling of nodes (i.e., computing devices) is no longer constrained by hierarchical interconnection structures. Bandwidth distribution within a node and between nodes may be more uniform, facilitating large-scale expansion of computing modules.

Using the optical interconnection structure described herein, interconnection among computing modules is not fixed, but instead is field-reconfigurable. This enables topology modification according to requirements of a particular artificial intelligence model.

From a topology perspective, data flow requirements of artificial intelligence models may generally be categorized into three types: Data parallelism, in which each computing module loads an entire model and different computing modules process different portions of a dataset; Model parallelism, in which certain layers of a model are sufficiently large that each computing module performs only a portion of computations associated with such layers; and Pipeline parallelism, in which different layers of a model are assigned to different computing modules for computation and different data flow patterns correspond to different interconnection topologies among computing modules. By using reconfigurable optical interconnection, different interconnection topologies among computing modules may be rapidly switched, thereby improving bandwidth utilization and enhancing scalability of artificial intelligence computing systems, enabling a plurality of computing modules to cooperate efficiently and reliably to accelerate large-scale models

Various aspects, features, and advantages of embodiments of the present invention will be described below with reference to the accompanying drawings.

### BRIEF DESCRIPTION OF THE DRAWINGS

FIG. 1 is a schematic cross-sectional view illustrating an example structure of an optical interconnection module according to an embodiment of the present invention.

FIG. 2A is a schematic diagram illustrating an example of a photonic circuit structure formed on a photonic integrated circuit chip in the optical interconnection module shown in FIG. 1; FIG. 2B is a schematic diagram illustrating another example of a photonic circuit structure formed on a photonic integrated circuit chip in the optical interconnection module shown in FIG. 1.

FIG. 3 is a schematic diagram illustrating a photonic circuit structure of an on-chip optical switch in the photonic integrated circuit chip shown in FIGS. 2A and 2B.

FIG. 4 is a schematic diagram illustrating an example structure of a first optical switching unit on the photonic integrated circuit chip shown in FIGS. 2A and 2B.

FIG. 5 is a schematic diagram illustrating an example structure of a second optical switching unit in the on-chip optical switch shown in FIG. 3.

FIG. 6 is a schematic diagram illustrating a planar layout of a reconfigurable optical interconnection expansion card according to an embodiment of the present invention.

FIG. 7 is a schematic diagram illustrating a packaging structure of the reconfigurable optical interconnection expansion card shown in FIG. 6.

FIG. 8 is a schematic diagram illustrating an example structure of a computing device according to an embodiment of the present invention.

FIG. 9 is a schematic diagram illustrating an example structure of a computing system according to an embodiment of the present invention.

FIGS. 10A to 10D are schematic diagrams respectively illustrating reconfigurable topological structures among computing modules in a computing device according to embodiments of the present invention.

### DETAILED DESCRIPTION OF THE INVENTION

The exemplary embodiments will be described below in greater detail with reference to the accompanying drawings. Certain terminology may be used in the following description for the purpose of reference only, and thus are not intended to be limiting. For example, terms such as “top”, “bottom”, “upper”, “lower”, “above”, and “below” could be used to refer to directions in the drawings to which reference is made. Terms such as “front”, “back”, “rear”, “side”, “outboard”, and “inboard” could be used to describe the orientation and/or location of portions of the component within a consistent but arbitrary frame of reference which is made clear by reference to the text and the associated drawings describing the component under discussion. Similarly, the terms “first”, “second”, and other such numerical terms referring to structures do not imply a sequence or order unless clearly indicated by the context.

It will be understood that when an element or feature is referred to as being “on,” “connected to,” or “coupled to” another element or layer, it can be directly on, connected to, or coupled to the other element or feature, or one or more intervening elements or features may be present. In addition, it will also be understood that when an element or features is referred to as being “between” two elements or features, it can be the only element or feature between the two elements or features, or one or more intervening elements or features may also be present.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively.

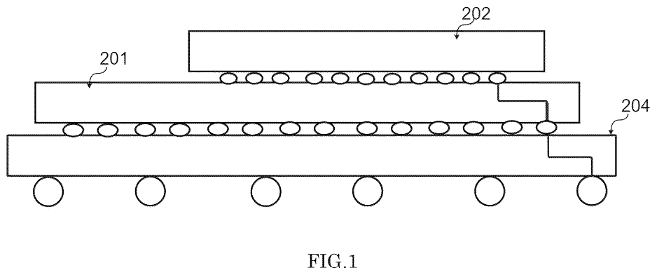

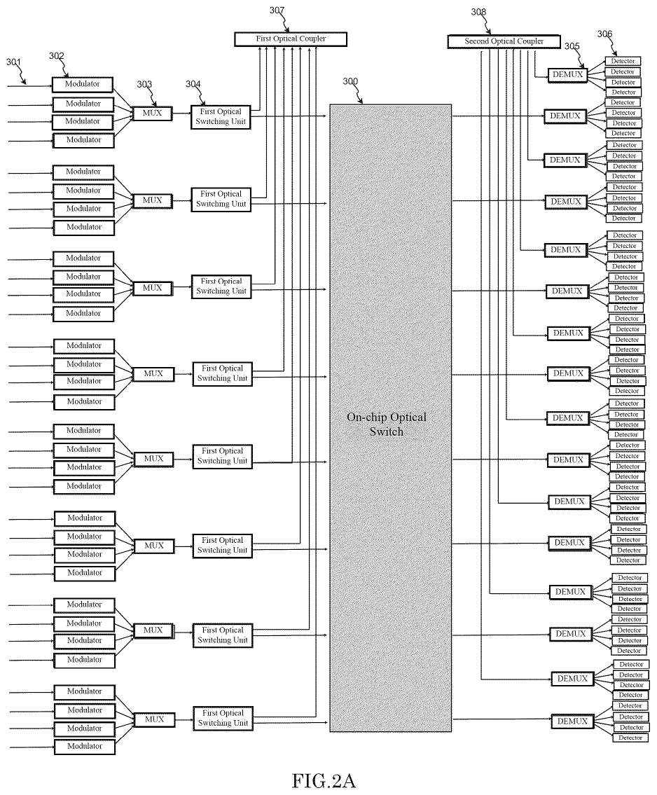

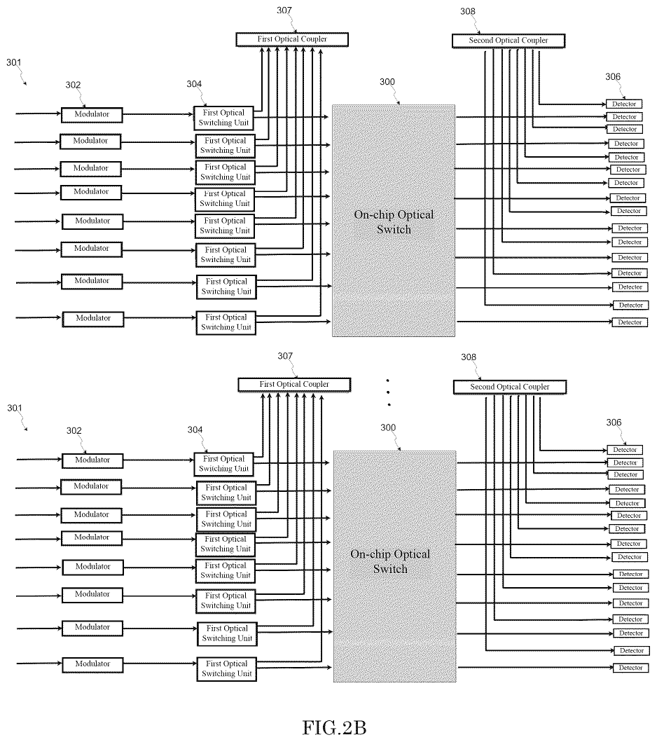

Referring to FIGS. 1-5, exemplary embodiments of an optical interconnection module are described. In some embodiments, the optical interconnection module includes a photonic integrated circuit (PIC) chip 201 and a transceiver analog electrical chip 202. As shown in FIG. 1, the PIC chip 201 is disposed on a substrate 204, and the transceiver analog electrical chip 202 is disposed on the PIC chip 201. As shown in FIG. 2A, the PIC chip 201 includes one or more PIC sub-modules. Each PIC sub-module includes a plurality of modulators 302, a plurality of wavelength multiplexers 303, a plurality of first optical switching units 304, at least one on-chip optical switch 300, a plurality of demultiplexers 305, a plurality of detectors 306, a first optical coupler 307, and a second optical coupler 308.

In an exemplary embodiment, a group of modulators 302 (which may be configured as a modulator array) is optically connected to one first optical switching unit 304 via one wavelength multiplexer 303. The wavelength multiplexer 303 includes a plurality of optical input ports and one optical output port. Each optical input port is connected to a respective modulator 302, and the optical output port is connected to the first optical switching unit 304.

Each first optical switching unit 304 is optically connected to a group of modulators 302 via a wavelength multiplexer 303. Each first optical switching unit 304 includes a first optical input port, a first optical output port, and a second optical output port. The first optical input port is connected to the optical output port of the wavelength multiplexer 303. The first optical output port is connected to the first optical coupler 307. The first optical coupler 307 optically connects the first optical output ports of the plurality of first optical switching units 304 to an external optical fiber. The second optical output port is connected to the on-chip optical switch 300. Each first optical switching unit 304 is configured to selectively output an optical signal received at the first optical input port via either the first optical output port or the second optical output port.

The on-chip optical switch 300 includes a plurality of optical input ports and a plurality of optical output ports. The optical input ports are respectively connected to the second optical output ports of the plurality of first optical switching units 304. The on-chip optical switch 300 is configured to selectively output an optical signal received at any one of the optical input ports via at least one of the optical output ports, thereby changing an output path of the optical signal and correspondingly changing a topology of an optical transmission network. The optical output ports of the on-chip optical switch 300 are respectively connected to a plurality of demultiplexers 305. Each demultiplexer 305 is connected to a group of detectors 306 (which may be configured as a detector array). Each demultiplexer 305 includes one optical input port and a plurality of optical output ports. The optical input port is connected to one optical output port of the on-chip optical switch 300, and each optical output port of the demultiplexer 305 is connected to a respective detector 306.

In an exemplary embodiment, each modulator array modulates light waves of different wavelengths. Each modulator 302 modulates input light 301 according to a driving analog electrical signal received from the transceiver analog electrical chip 202, thereby loading information carried by the electrical signal onto the input light to generate an optical signal carrying information. The wavelength multiplexer 303 combines optical signals of different wavelengths into a single optical signal. The combined optical signal is selectively routed by the first optical switching unit 304 to either a first external optical fiber array (not shown) via the first optical coupler 307, or to the on-chip optical switch 300. If routed to the on-chip optical switch 300, the optical signal is demultiplexed by the demultiplexer 305 into optical signals of different wavelengths and transmitted to corresponding detectors 306 for photoelectric conversion. If routed to the first external optical fiber array, the optical signal is transmitted through an external optical fiber to a demultiplexer and detector array on another chip. In some embodiments, the PIC chip 201 further includes a second optical coupler 308 configured to receive an optical signal from a second external optical fiber array (not shown) and transmit the optical signal to the demultiplexer 305 and associated detector array on the PIC chip 201.

In some embodiments, the transceiver analog electrical chip 202 is configured to convert a first digital electrical signal into a driving analog electrical signal and transmit the driving analog electrical signal carrying the information to at least one modulator 302 in the PIC chip 201, or to receive an analog electrical signal output by at least one detector 306 in the PIC chip 201 and convert the received analog electrical signal into a second digital electrical signal. The modulator 302 is configured to modulate the information carried by the driving analog electrical signal onto the optical signal.

In some embodiments, as shown in FIG. 1, the transceiver analog electrical chip 202 is disposed above the PIC chip 201 and communicates the first digital electrical signal and/or the second digital electrical signal through conductive vias extending through the PIC chip 201. The transceiver analog electrical chip 202 is mounted on a side of the PIC chip 201 opposite the substrate 204.

In alternative embodiments, when the input light 301 is single-wavelength light, the PIC chip 201 may be configured without wavelength multiplexers 303 and demultiplexers 305. As shown in FIG. 2B, one first optical switching unit 304 corresponds to one modulator 302 and two detectors. One detector is connected to the on-chip optical switch 300, and the other detector is connected to the first external optical fiber array via the first optical coupler 307. In some embodiments, the second optical coupler 308 may be directly connected to a detector 306 such that the detector 306 may be connected through a second external optical fiber array to a first optical switching unit of another chip.

In other embodiments, as shown in FIG. 2B, the PIC chip includes a plurality of PIC sub-modules, each having substantially the same circuit structure.

In some embodiments, the PIC chip 201 further includes a third optical coupler (not shown) and an optical power splitter (not shown). The third optical coupler is configured to receive light from an off-chip light source. The optical power splitter is optically connected to the third optical coupler and is configured to split input light into a plurality of output lights having substantially equal power, which are transmitted to respective modulators 302.

In some embodiments, the first optical switching unit 304 is a 1×2 optical switching unit. The first optical switching unit 304 may be implemented as a MEMS optical circuit switching unit or a Mach-Zehnder interferometer (MZI) optical circuit switching unit. As shown in FIG. 4, the first optical switching unit 304 may include a Mach-Zehnder interferometer structure comprising: a first beam splitter 408 having one optical input port and two optical output ports; a second beam splitter 407 having two optical input ports and two optical output ports; and two phase shifters 406 respectively connected between the two optical output ports of the first beam splitter 408 and the two optical input ports of the second beam splitter 407. The phase shifters 406 may be electro-optic or thermo-optic phase shifters. By controlling the phase shifters 406 on upper and lower arms, a phase of an optical signal may be adjusted and an output port may be selected based on interference effects.

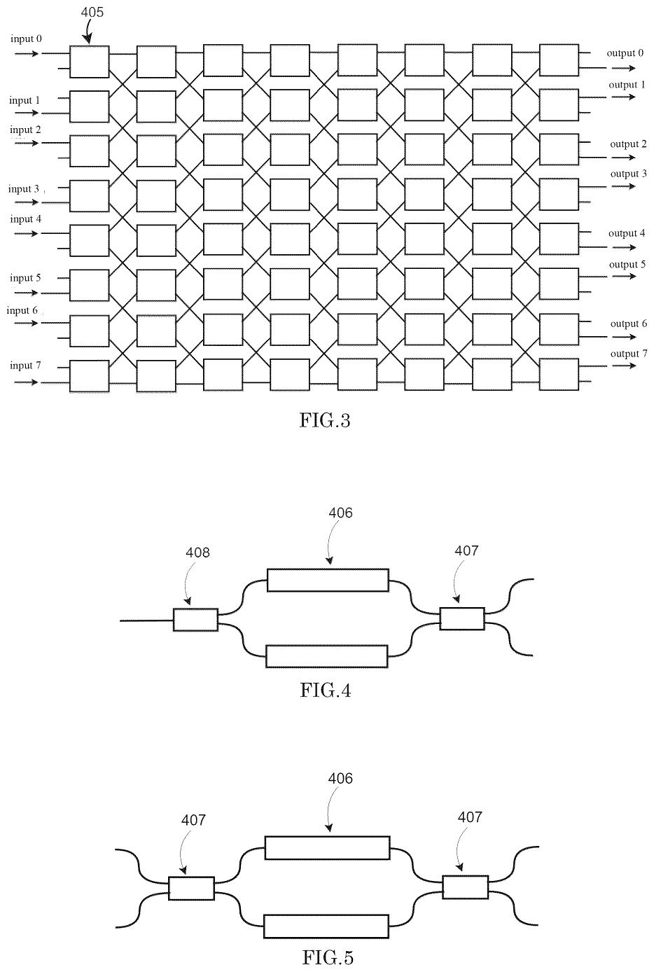

In some embodiments, as shown in FIG. 3, the on-chip optical switch 300 includes a plurality of second optical switching units 405. The optical interconnection module further includes an optical switching control analog electrical chip (not shown) configured to control the plurality of second optical switching units 405 to select a transmission path for an optical signal received at the on-chip optical switch 300, such that the optical signal is output from at least one optical output port of the on-chip optical switch. In some embodiments, the on-chip optical switch 300 is an 8×8 strictly non-blocking optical switch including sixty-four 2×2 optical switching units 405. By controlling the signal output port of each switching unit, any arbitrary combination of paths between 8 input channels and 8 output channels in FIG. 3 can be established, and insertion loss along each path is substantially independent of path selection. Thus, the topology from input ends to output ends in the system can be reconfigured. In specific applications, the 8×8 silicon optical switch can be further replicated laterally to meet larger bandwidth switching requirements. The optical switch structure in this embodiment is exemplary. Depending on actual needs, the on-chip optical switch may be implemented as any n×n non-blocking optical switch. Reconfigurable optical interconnection may change a network topology for different artificial intelligence applications to optimize data migration efficiency and improve system performance.

In some embodiments, the second optical switching unit 405 is implemented as an MZI optical circuit switching unit.

In some embodiments, as shown in FIG. 5, the second optical switching unit adopts an MZI optical circuit switching unit, which includes two beam splitters 407, each beam splitter 407 having two optical input ports and two optical output ports; and two phase shifters 406 respectively connected between the two optical output ports of one beam splitter 407 and the two optical input ports of the other beam splitter 407. It can be seen that the second optical switching unit can also adopt a Mach-Zehnder interferometer structure. By controlling the phase shifters 406, a phase of an input optical signal may be adjusted and an output port may be selected based on interference effects.

In some embodiments, the modulator 302 includes at least one of: a microring modulator, a Mach-Zehnder modulator, or an electro-absorption modulator. The detector 306 includes a microring detector or a photodiode.

In some implementations, each of the PIC sub-modules further includes a third optical switching unit (not shown). The detector or demultiplexer is optically connected to the on-chip optical switch and the second optical coupler via the third optical switching unit. The number of detectors or detector arrays is equal to the number of modulators or modulator arrays. Specifically, the third optical switching unit includes a first optical input port, a second optical input port, and an optical output port. The first optical input port of the third optical switching unit is connected to the second optical coupler. The second optical input port of the third optical switching unit is connected to one optical output port of the on-chip optical switch. The optical output port of the third optical switching unit is connected to the detector or the demultiplexer. By controlling the third optical switching unit, either the first optical input port or the second optical input port of the third optical switching unit is connected to the optical output port of the third optical switching unit.

In some implementations, the third optical switching units are respectively disposed on the optical path connecting the detector or detector array to the on-chip optical switch, and on the optical path connecting the detector or detector array to the second optical coupler.

In some implementations, the third optical switching unit is a MEMS optical circuit switching unit or an MZI optical circuit switching unit. By providing the third optical switching unit, one detector or detector array can be used at different times to receive optical signals from the on-chip optical switch and optical signals from the second optical coupler, thereby reducing the total number of detectors or detector arrays.

In conventional systems, point-to-point full interconnection between computing modules is implemented on a universal base board using PCB traces. Such PCB traces may be insufficient to meet bandwidth requirements between computing modules. By adopting the optical interconnection module described herein, bandwidth within a node and between nodes may be made more uniform, thereby facilitating large-scale expansion of computing modules. In addition, reconfigurable optical interconnection enables dynamic modification of network topology to accommodate different artificial intelligence (AI) applications, thereby improving data migration efficiency and overall computing system performance.

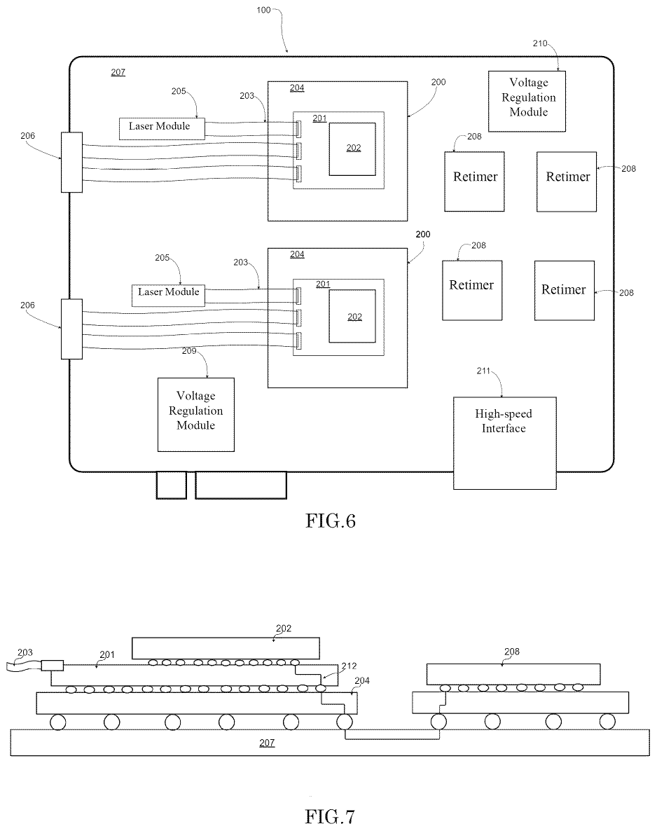

In some embodiments, the optical interconnection module is disposed on an optical interconnection expansion card to facilitate pluggable connection with a computing device. FIGS. 6 and 7 illustrate an exemplary optical interconnection expansion card 100. Because the optical interconnection module provides reconfigurable optical interconnection, the expansion card may also be referred to as a reconfigurable optical interconnection expansion card. As shown in FIGS. 6 and 7, the optical interconnection expansion card 100 includes: a PCB 207, an optical interconnection module 200, a laser module 205, an optical fiber interface 206, an electrical communication interface (illustratively a high-speed interface 211), a retimer 208, a first voltage regulation module 209 (e.g., 54V to 12V), and a second voltage regulation module 210 (e.g., 12V to a voltage rail).

The optical interconnection module 200 is disposed on the PCB 207 and may adopt the optical interconnection module described in any of the above embodiments or implementations, including the PIC chip 201, the transceiver analog electrical chip 202, and the corresponding substrate 204. The laser module 205 is disposed on the PCB 207 and optically connected to the optical interconnection module 200 via a third optical fiber array 203 to provide input light. The optical fiber interface 206 is disposed on the PCB 207 and optically connected to the optical interconnection module 200 via first and second external optical fiber arrays to enable optical communication. The high-speed interface 211 is disposed on the PCB 207 for receiving the first digital signal and/or sending the second digital electrical signal. The retimer 208 is disposed on the PCB 207 and is communicatively connected to the high-speed interface 211 and the optical interconnection module 200. The retimer 208 is configured to: reshape the first digital electrical signal before transmitting it to the optical interconnection module 200; and/or reshape a second digital electrical signal received from the optical interconnection module 200 before transmitting it via the electrical communication interface. Each retimer 208 has a plurality of communication channels, and the electrical communication interfaces have a plurality of communication channels. The total number of communication channels of the retimers 208 equals the total number of electrical channels of the electrical communication interfaces. The retimer 208 is communicatively connected to the optical interconnection module 200 via PCB traces.

An electrical signal received by the high-speed interface 211 from an information sending device, e.g., a computing module, is reshaped by the retimer 208. The reshaped signal is transmitted through traces on the package substrate and PCB 207 to the optical interconnection module 200, and further through metal traces on the substrate 204 and through-silicon vias 212 to the transceiver analog electrical chip 202. The transceiver analog electrical chip 202 and the PIC chip 201 perform signal amplification and electro-optic conversion, then the signal is transmitted via optical fibers, and optical path reconfiguration is performed in the PIC chip 201. For example, laser light generated by the laser module 205 is input into the optical interconnection module 200 is modulated in accordance with the electrical signal received from the transceiver analog electrical chip 202 via the modulator to generate an optical signal carrying information. After optical path reconfiguration by the first optical switching unit and the on-chip optical switch within the PIC chip 201, the optical signal is output to a communication peer (e.g., another computing module) via an optical fiber and the optical fiber interface 206. Conversely, an optical signal received via the optical fiber interface 206 undergoes photoelectric conversion by the detector of the optical interconnection module 200. The resulting electrical signal is transmitted to a receiving end (e.g., a computing module) via the transceiver analog electrical chip 202, the retimer 208, and the high-speed interface 211.

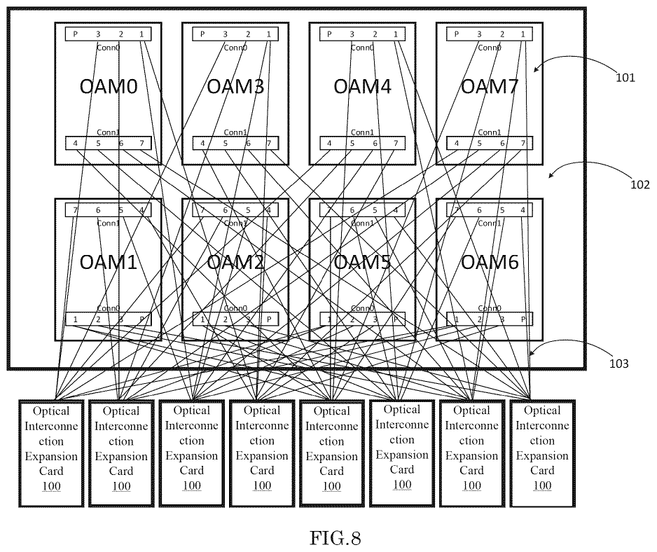

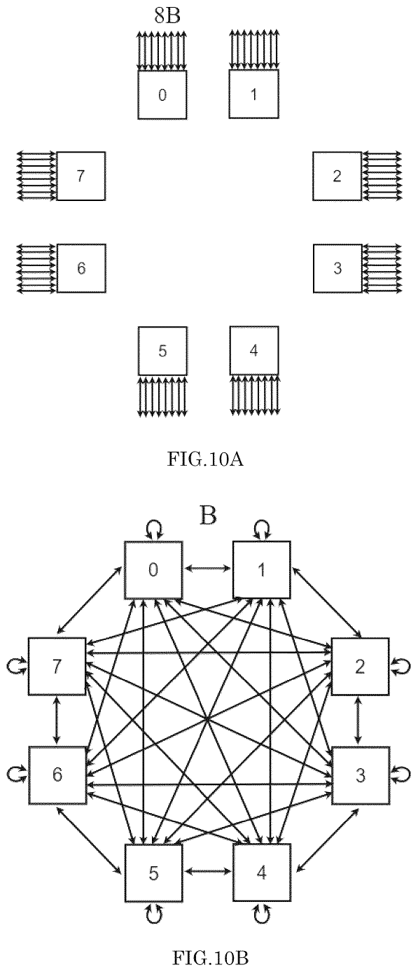

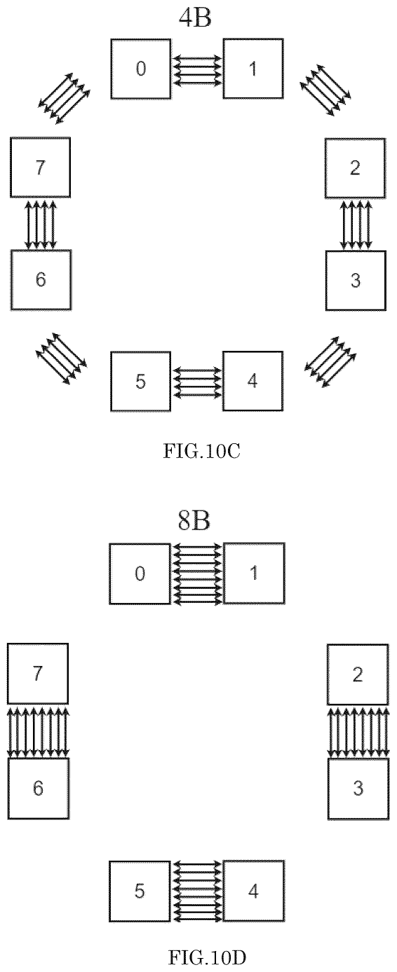

In some embodiments, a plurality of computing modules 101 are communicatively connected through a plurality of optical interconnection expansion cards 100 to form a computing device. As shown in FIG. 8, the computing device includes: a plurality of computing modules 101 (for example, eight OAM modules numbered 0, 1, 2, 3, 4, 5, 6, 7, each carrying one or more computing chips on an OAM board), a plurality of optical interconnection expansion cards 100 (e.g., 8 optical interconnection expansion cards), and a PCB 102. The PCB 102 may be a universal base board (UBB). In some embodiments, the computing modules 101 are connected to the optical interconnection expansion cards 100 via PCB traces 103 and communicate through high-speed long-reach SerDes interfaces coupled to the high-speed interfaces 211 to form an eight-card system. By controlling the first optical switching units and the on-chip optical switches within the optical interconnection expansion cards 100, the connection topology among the computing modules 101 may be reconfigured. For example, the connection topology among the computing modules 101 (numbered 0, 1, 2, 3, 4, 5, 6, 7) can be reconfigured in real-time to full external interconnection (FIG. 10A), internal full interconnection (FIG. 10B), ring topology (FIG. 10C), or point-to-point topology (FIG. 10D). Accordingly, communication bandwidth between computing module 0 and computing module 1 can be switched in real-time among bandwidth B (FIG. 10B: full interconnection), bandwidth 4B (FIG. 10C: ring), and bandwidth 8B (FIG. 10D: point-to-point), depending on the selected topology. This can match the bandwidth requirements of different communication algorithms, improve bandwidth utilization, and thus enhance the overall operational efficiency of the AI computing system.

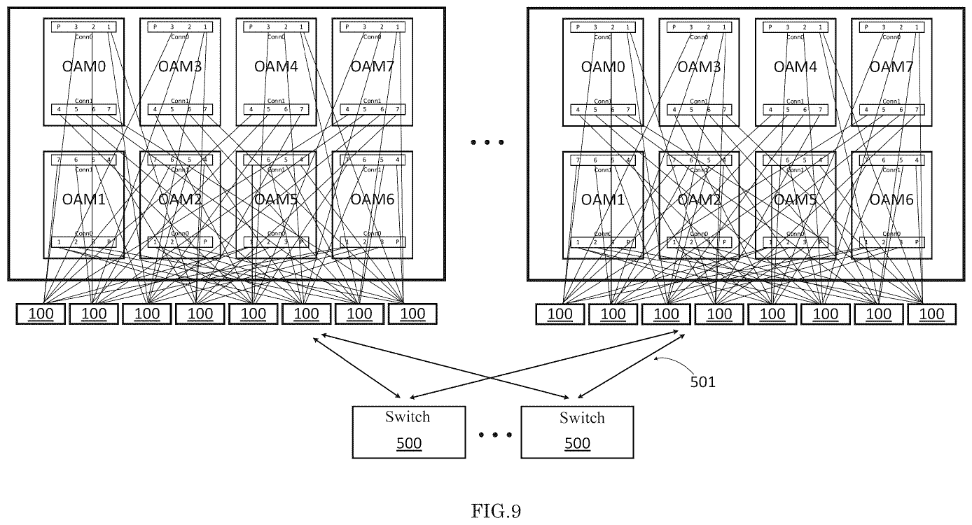

In addition, as shown in FIG. 9, the above-described eight-card system may be interconnected through optical fibers 501 via the optical interconnection expansion cards 100 and a switch 500, thereby forming a larger-scale computing system. The switch 500 may be an optical circuit switch or an electrical switch equipped with an optical module. That is, embodiments of the present disclosure further relate to a computing system including: a plurality of the computing devices described above; and at least one switch. The plurality of optical interconnection expansion cards of the plurality of computing devices are communicatively connected to the at least one switch through optical fibers so as to interconnect the plurality of computing devices. Depending on specific application requirements, the computing devices may be horizontally scaled, thereby enabling the computing system to provide greater computing capability and to satisfy the requirements of large-scale artificial intelligence models.

Those skilled in the art will appreciate that the above disclosure is merely embodiments of the present invention and, of course, should not be used to limit the scope of the patent protection sought by the present invention. Equivalent changes made according to the embodiments of the present invention still fall within the scope of the claims.

Furthermore, the technical solutions described above may further be expressed as follows.

### Embodiment 1

A photonic integrated circuit (PIC) chip comprising one or more photonic integrated circuit sub-modules, each sub-module comprising:
a plurality of first optical switching units, each first optical switching unit comprising a first optical input port, a first optical output port, and a second optical output port, and being configured to selectively output an optical signal received at the first optical input port via either the first optical output port or the second optical output port;
at least one on-chip optical switch comprising a plurality of optical input ports and a plurality of optical output ports, wherein the plurality of optical input ports are respectively optically connected to the second optical output ports of the plurality of first optical switching units, and the at least one on-chip optical switch is configured to selectively output an optical signal received at any one of the plurality of optical input ports via at least one of the plurality of optical output ports;
a plurality of modulators optically connected to corresponding first optical input ports of the plurality of first optical switching units and configured to modulate information carried by an electrical signal onto the optical signal;
a plurality of detectors, at least a portion of the plurality of detectors being optically connected to the plurality of optical output ports of the at least one on-chip optical switch;
a plurality of first optical couplers configured to optically connect the first optical output ports of the plurality of first optical switching units to a first external optical fiber array; and
a second optical coupler optically connected to at least a portion of the plurality of detectors and configured to transmit optical signals from a second external optical fiber array to the portion of the plurality of detectors.

### Embodiment 2

The PIC chip according to Embodiment 1, wherein each photonic integrated circuit sub-module further comprises a plurality of wavelength multiplexers and a plurality of demultiplexers;
wherein the plurality of modulators are arranged as a plurality of modulator arrays, and the detectors are arranged as a plurality of detector arrays;
wherein each modulator array is optically connected to a corresponding first optical switching unit via a respective wavelength multiplexer of the plurality of wavelength multiplexers, wherein each wavelength multiplexer comprises a plurality of optical input ports and one optical output port, wherein each of the plurality of optical input ports is connected to a respective modulator of the modulator array, and the optical output port is connected to the first optical input port of a corresponding first optical switching unit; and
wherein each detector array is optically connected to a corresponding optical output port of the at least one on-chip optical switch or to the second optical coupler via a respective demultiplexer of the plurality of demultiplexers, wherein each demultiplexer comprises one optical input port and a plurality of optical output ports, the optical input port is connected to one optical output port of the at least one on-chip optical switch or to the second optical coupler, and each of the plurality of optical output ports is connected to a respective detector in the detector array.

### Embodiment 3

The PIC chip according to Embodiment 1 or 2, wherein a number of detectors or detector arrays is twice a number of modulators or modulator arrays, and wherein a portion of the detectors or detector arrays is connected to the at least one on-chip optical switch, and a second portion of the detectors or detector arrays is connected to the second optical coupler.

### Embodiment 4

The PIC chip according to Embodiment 1 or 2, wherein each photonic integrated circuit sub-module further comprises a third optical switching unit, the detectors or demultiplexers are optically connected to the at least one on-chip optical switch and the second optical coupler via the third optical switching unit, and wherein a number of detectors or detector arrays is equal to a number of modulators or modulator arrays.

### Embodiment 5

The PIC chip according to Embodiment 4, wherein the third optical switching unit comprises a first optical input port, a second optical input port, and an optical output port;
wherein the first optical input port of the third optical switching unit is connected to the second optical coupler, the second optical input port of the third optical switching unit is connected to one optical output port of the at least one on-chip optical switch, the optical output port of the third optical switching unit is connected to a respective detector or demultiplexer, and
wherein the third optical switching unit is configured to selectively establish optical communication between its first optical input port and its optical output port or between its second optical input port and its optical output port.

### Embodiment 6

The PIC chip according to Embodiment 4, wherein the third optical switching unit is respectively disposed on an optical path between the detector or detector array and the at least one on-chip optical switch, and on an optical path between the detector or detector array and the second optical coupler.

### Embodiment 7

The PIC chip according to Embodiment 4, wherein the third optical switching unit comprises a MEMS optical circuit switching unit or a Mach-Zehnder interferometer (MZI) optical circuit switching unit.

### Embodiment 8

The PIC chip according to Embodiment 1 or 2, wherein the at least one on-chip optical switch comprises a plurality of second optical switching units configured to select transmission paths for optical signals input to the at least one on-chip optical switch such that the optical signals are output from at least one optical output port of the at least one on-chip optical switch.

### Embodiment 9

The PIC chip according to Embodiment 8, wherein each first optical switching unit comprises a MEMS optical circuit switching unit or an MZI optical circuit switching unit; and/or
the second optical switching unit comprises an MZI optical circuit switching unit.

### Embodiment 10

The PIC chip according to Embodiment 9, wherein each first optical switching unit comprises an MZI optical circuit switching unit, the MZI optical circuit switching unit including:
a first beam splitter having one optical input port and two optical output ports;
a second beam splitter having two optical input ports and two optical output ports; and
two phase shifters respectively connected between the two optical output ports of the first beam splitter and the two optical input ports of the second beam splitter.

### Embodiment 11

The PIC chip according to Embodiment 8, wherein each second optical switching unit comprises:
two beam splitters each having two optical input ports and two optical output ports, the two beam splitters including a first beam splitter and a second beam splitter;
two phase shifters respectively connected between the two optical output ports of the first beam splitter and the two optical input ports of the second beam splitter.

### Embodiment 12

The PIC chip according to Embodiment 1 or 2, wherein each modulator comprises at least one of: a microring modulator, a Mach-Zehnder modulator, and an electro-absorption modulator;
and/or, each detector comprises a microring detector or a photodiode.

### Embodiment 13

The PIC chip according to Embodiment 1 or 2, wherein each photonic integrated circuit sub-module further comprises:
a third optical coupler configured to receive light from an off-chip light source;
an optical power splitter optically connected to the third optical coupler and configured to split input light into a plurality of output lights having substantially equal power, the plurality of output lights being transmitted to respective modulators.

### Embodiment 14

An optical interconnection module comprising the PIC chip according to any one of Embodiments 1 to 13 and a transceiver analog electrical chip;
wherein the transceiver analog electrical chip is configured to convert a received first digital electrical signal into a driving analog electrical signal carrying information and transmit the driving analog electrical signal to at least one modulator of the PIC chip, or receive an analog electrical signal output from at least one detector of the PIC chip and convert the analog electrical signal into a second digital electrical signal; and
wherein the at least one modulator is configured to modulate the information carried by the driving analog electrical signal onto the optical signal.

### Embodiment 15

The optical interconnection module according to Embodiment 14, wherein the transceiver analog electrical chip is disposed above the PIC chip and configured to receive the first digital electrical signal and/or to transmit the second digital electrical signal through conductive vias extending through the PIC chip.

### Embodiment 16

The optical interconnection module according to Embodiment 14, further comprising an optical switching control analog electrical chip corresponding to the on-chip optical switch in the PIC chip and configured to control the plurality of second optical switching units to select a transmission path for an optical signal received at the on-chip optical switch such that the optical signal is output from a predetermined optical output port.

### Embodiment 17

The optical interconnection module according to Embodiment 16, wherein the optical switching control analog electrical chip is disposed above the PIC chip and configured to receive an optical switching control analog signal through conductive vias extending through the PIC chip.

### Embodiment 18

The optical interconnection module according to Embodiment 14, further comprising a substrate, wherein the PIC chip is mounted on the substrate, and the transceiver analog electrical chip is mounted on a side of the PIC chip opposite the substrate.

### Embodiment 19

An optical interconnection expansion card, comprising:
a first printed circuit board (PCB);
the optical interconnection module according to any one of Embodiments 14 to 18 disposed on the first PCB;
a plurality of optical fiber interfaces disposed on the first PCB and optically connected to the optical interconnection module via the first external optical fiber array and the second external optical fiber array to implement optical communication with the optical interconnection module;
a plurality of electrical communication interfaces disposed on the first PCB and configured to receive the first digital electrical signals and/or transmit the second digital electrical signals; and;
a plurality of retimers disposed on the first PCB and communicatively connected to the plurality of electrical communication interfaces and the optical interconnection module, the plurality of retimers being configured to: retime the first digital electrical signals and transmit retimed electrical signals to the optical interconnection module; and/or retime the second digital electrical signals received from the optical interconnection module and transmit the retimed signals through the plurality of electrical communication interfaces.

### Embodiment 20

The optical interconnection expansion card according to Embodiment 19, wherein each retimer comprises a plurality of communication channels,
the plurality of electrical communication interfaces comprises a plurality of communication channels, and
a total number of communication channels of the plurality of retimers is equal to a total number of electrical communication channels of the plurality of electrical communication interfaces.

### Embodiment 21

The optical interconnection expansion card according to Embodiment 19, wherein the plurality of retimers are communicatively connected to the optical interconnection module via PCB traces on the first PCB.

### Embodiment 22

The optical interconnection expansion card according to Embodiment 19, further comprising a laser module disposed on the first PCB and optically connected to the optical interconnection module via a third optical fiber array to transmit a laser beam to the optical interconnection module.

### Embodiment 23

A computing device, comprising:
a plurality of computing modules; and
a plurality of optical interconnection expansion cards according to any one of Embodiments 19 to 22;
wherein the plurality of computing modules are communicatively connected to the plurality of optical interconnection expansion cards.

### Embodiment 24

The computing device according to Embodiment 23, further comprising a second printed circuit board (PCB),
wherein the plurality of computing modules are disposed on the second PCB,
the plurality of optical interconnection expansion cards are plugged into the second PCB, and
the plurality of computing modules are communicatively connected to the plurality of optical interconnection expansion cards via PCB traces on the second PCB.

### Embodiment 25

A computing system, comprising:
a plurality of computing devices according to Embodiment 23 or 24;
at least one switch;
wherein the plurality of optical interconnection expansion cards of the plurality of computing devices are communicatively connected to the at least one switch through optical fibers so as to communicatively connect the plurality of computing devices.

### Embodiment 26

The computing system according to Embodiment 25, wherein the at least one switch comprises an optical circuit switch or an electrical switch including an optical module configured to perform optical communication with the plurality of optical interconnection expansion cards.

1-26. (canceled)

27. A photonic integrated circuit (PIC) chip, comprising one or more photonic integrated circuit sub-modules, each sub-module comprising:
a plurality of first optical switching units, each first optical switching unit comprising a first optical input port, a first optical output port, and a second optical output port, and being configured to selectively output an optical signal received at the first optical input port via either the first optical output port or the second optical output port;
at least one on-chip optical switch comprising a plurality of optical input ports and a plurality of optical output ports, wherein the plurality of optical input ports are respectively optically connected to the second optical output ports of the plurality of first optical switching units, and the at least one on-chip optical switch is configured to selectively output an optical signal received at any one of the plurality of optical input ports via at least one of the plurality of optical output ports;
a plurality of modulators optically connected to corresponding first optical input ports of the plurality of first optical switching units and configured to modulate information carried by an electrical signal onto the optical signal;
a plurality of detectors, at least a portion of the plurality of detectors being optically connected to the plurality of optical output ports of the at least one on-chip optical switch;
a plurality of first optical couplers configured to optically connect the first optical output ports of the plurality of first optical switching units to a first external optical fiber array; and
a second optical coupler optically connected to at least a portion of the plurality of detectors and configured to transmit optical signals from a second external optical fiber array to the portion of the plurality of detectors.

28. The PIC chip according to claim 27, wherein each photonic integrated circuit sub-module further comprises a plurality of wavelength multiplexers and a plurality of demultiplexers;
wherein the plurality of modulators are arranged as a plurality of modulator arrays, and the detectors are arranged as a plurality of detector arrays;
wherein each modulator array is optically connected to a corresponding first optical switching unit via a respective wavelength multiplexer of the plurality of wavelength multiplexers, wherein each wavelength multiplexer comprises a plurality of optical input ports and one optical output port, wherein each of the plurality of optical input ports is connected to a respective modulator of the modulator array, and the optical output port is connected to the first optical input port of a corresponding first optical switching unit; and
wherein each detector array is optically connected to a corresponding optical output port of the at least one on-chip optical switch or to the second optical coupler via a respective demultiplexer of the plurality of demultiplexers, wherein each demultiplexer comprises one optical input port and a plurality of optical output ports, the optical input port is connected to one optical output port of the at least one on-chip optical switch or to the second optical coupler, and each of the plurality of optical output ports is connected to a respective detector of the detector array.

29. The PIC chip according to claim 27, wherein a number of detectors or detector arrays is twice a number of modulators or modulator arrays, and wherein a portion of the detectors or detector arrays is connected to the at least one on-chip optical switch, and a second portion of the detectors or detector arrays is connected to the second optical coupler.

30. The PIC chip according to claim 27, wherein each photonic integrated circuit sub-module further comprises a third optical switching unit, the detectors or demultiplexers are optically connected to the at least one on-chip optical switch and the second optical coupler via the third optical switching unit, and wherein a number of detectors or detector arrays is equal to a number of modulators or modulator arrays.

31. The PIC chip according to claim 30, wherein the third optical switching unit is respectively disposed on an optical path between the detector and the at least one on-chip optical switch, and on an optical path between the detector and the second optical coupler.

32. The PIC chip according to claim 27, wherein the at least one on-chip optical switch comprises a plurality of second optical switching units configured to select transmission paths for optical signals input to the at least one on-chip optical switch such that the optical signals are output from at least one optical output port of the at least one on-chip optical switch.

33. The PIC chip according to claim 32, wherein each first optical switching unit comprises a MEMS optical circuit switching unit or an MZI optical circuit switching unit; and/or
the second optical switching unit comprises an MZI optical circuit switching unit.

34. An optical interconnection module, comprising:
the PIC chip according to claim 27; and
a transceiver analog electrical chip configured to: convert a received first digital electrical signal into a driving analog electrical signal carrying information, and transmit the driving analog electrical signal to at least one modulator of the PIC chip, or receive an analog electrical signal output from at least one detector of the PIC chip and convert the analog electrical signal into a second digital electrical signal;
wherein the at least one modulator is configured to modulate the information carried by the driving analog electrical signal onto the optical signal.

35. The optical interconnection module according to claim 34, wherein the transceiver analog electrical chip is disposed above the PIC chip and configured to receive the first digital electrical signal and/or to transmit the second digital electrical signal through conductive vias extending through the PIC chip.

36. The optical interconnection module according to claim 34, wherein the at least one on-chip optical switch comprises a plurality of second optical switching units configured to select transmission paths for optical signals input to the at least one on-chip optical switch such that the optical signals are output from at least one optical output port of the at least one on-chip optical switch.

37. The optical interconnection module according to claim 36, further comprising an optical switching control analog electrical chip corresponding to the on-chip optical switch in the PIC chip and configured to control the plurality of second optical switching units to select a transmission path for an optical signal received at the on-chip optical switch such that the optical signal is output from a predetermined optical output port.

38. The optical interconnection module according to claim 37, wherein the optical switching control analog electrical chip is disposed above the PIC chip and configured to receive an optical switching control analog signal through conductive vias extending through the PIC chip.

39. The optical interconnection module according to claim 34, further comprising a substrate, wherein the PIC chip is mounted on the substrate, and the transceiver analog electrical chip is mounted on a side of the PIC chip opposite the substrate.

40. The optical interconnection module according to claim 34, wherein each photonic integrated circuit sub-module further comprises a plurality of wavelength multiplexers and a plurality of demultiplexers;
wherein the plurality of modulators are arranged as a plurality of modulator arrays, and the detectors are arranged as a plurality of detector arrays;
wherein each modulator array is optically connected to a corresponding first optical switching unit via a respective wavelength multiplexer of the plurality of wavelength multiplexers, wherein each wavelength multiplexer comprises a plurality of optical input ports and one optical output port, wherein each of the plurality of optical input ports is connected to a respective modulator of the modulator array, and the optical output port is connected to the first optical input port of a corresponding first optical switching unit; and
wherein each detector array is optically connected to a corresponding optical output port of the at least one on-chip optical switch or to the second optical coupler via a respective demultiplexer of the plurality of demultiplexers, wherein each demultiplexer comprises one optical input port and a plurality of optical output ports, the optical input port is connected to one optical output port of the at least one on-chip optical switch or to the second optical coupler, and each of the plurality of optical output ports is connected to a respective detector of the detector array.

41. An optical interconnection expansion card, comprising:
a first printed circuit board (PCB);
the optical interconnection module according to claim 34 disposed on the first PCB;
a plurality of optical fiber interfaces disposed on the first PCB and optically connected to the optical interconnection module via the first external optical fiber array and the second external optical fiber array to implement optical communication with the optical interconnection module;
a plurality of electrical communication interfaces disposed on the first PCB and configured to receive the first digital electrical signals and/or transmit the second digital electrical signals; and;
a plurality of retimers disposed on the first PCB and communicatively connected to the plurality of electrical communication interfaces and the optical interconnection module, the plurality of retimers being configured to: retime the first digital electrical signals and transmit retimed electrical signals to the optical interconnection module; and/or retime the second digital electrical signals received from the optical interconnection module and transmit the retimed signals through the plurality of electrical communication interfaces.

42. The optical interconnection expansion card according to claim 41, further comprising an optical switching control analog electrical chip corresponding to the on-chip optical switch in the PIC chip and configured to control the on-chip optical switch to select a transmission path for an optical signal received at the on-chip optical switch such that the optical signal is output from a predetermined optical output port.

43. The optical interconnection expansion card according to claim 41, wherein the plurality of retimers are communicatively connected to the optical interconnection module via PCB traces on the first PCB.

44. The optical interconnection expansion card according to claim 41, wherein each photonic integrated circuit sub-module further comprises a plurality of wavelength multiplexers and a plurality of demultiplexers;
wherein the plurality of modulators are arranged as a plurality of modulator arrays, and the detectors are arranged as a plurality of detector arrays;
wherein each modulator array is optically connected to a corresponding first optical switching unit via a respective wavelength multiplexer of the plurality of wavelength multiplexers, wherein each wavelength multiplexer comprises a plurality of optical input ports and one optical output port, wherein each of the plurality of optical input ports is connected to a respective modulator of the modulator array, and the optical output port is connected to the first optical input port of a corresponding first optical switching unit; and
wherein each detector array is optically connected to a corresponding optical output port of the at least one on-chip optical switch or to the second optical coupler via a respective demultiplexer of the plurality of demultiplexers, wherein each demultiplexer comprises one optical input port and a plurality of optical output ports, the optical input port is connected to one optical output port of the at least one on-chip optical switch or to the second optical coupler, and each of the plurality of optical output ports is connected to a respective detector of the detector array.

45. A computing device, comprising:
a plurality of computing modules; and
a plurality of optical interconnection expansion cards according to claim 41;
wherein the plurality of computing modules are communicatively connected to the plurality of optical interconnection expansion cards.

46. The computing device according to claim 45, further comprising a second printed circuit board (PCB),
wherein the plurality of computing modules are disposed on the second PCB,
the plurality of optical interconnection expansion cards are plugged into the second PCB, and
the plurality of computing modules are communicatively connected to the plurality of optical interconnection expansion cards via PCB traces on the second PCB.

47. A computing system, comprising:
a plurality of computing devices according to claim 45; and
at least one switch;
wherein the plurality of optical interconnection expansion cards of the plurality of computing devices are communicatively connected to the at least one switch through optical fibers so as to communicatively connect the plurality of computing devices.

48. The computing system according to claim 47, wherein the at least one switch comprises an optical circuit switch or an electrical switch including an optical module configured to perform optical communication with the plurality of optical interconnection expansion cards.
